(19) United States
(12) Patent Application Publication
(10) Pub. No.: US 2013/0204649 A1
(43) Pub. Date: Aug. 8, 2013

(54) Cloud Risk Reporting Arrangement and Method

(71) Applicant: Amy Lynn VAN ANTWERP, Campbell, CA (US)

(72) Inventor: Amy Lynn VAN ANTWERP, Campbell, CA (US)

(21) Appl. No.: 13/366,562

(22) Filed: Feb. 6, 2012

(51) Int. Cl. G06Q 10/00

(52) U.S. Cl. 705/7.11

(57) ABSTRACT

A reporting system for reporting metric date from a supplier network to at least one dependent includes a collector that is adapted to receive the metric data from the supplier network through at least one collection channel. A processing system analyzes the metric data based on at least one threshold, which determines if one of the at least one dependent requires a service advisory notification due to any of the metric data exceeding at least one of the at least one threshold. A notification system is adapted to send the service advisory notice to the at least one dependent at successive dependent addresses when so directed by the processing system, and to an auditor that is further adapted to detect a fault condition when a heartbeat signal is not received as expected from the processing system.

### FIELD OF THE INVENTION

The present invention relates generally to automated notification systems, and more particularly to a notification system for reporting metric and risk data from a supplier network to one or more dependents requiring such data.

### DISCUSSION OF RELATED ART

Supplier networks of nearly every type can experience a general failure when one or more components fails in some way to deliver a product or service as expected. For example, an Internet Service Provider (ISP) may fail to deliver Internet connectivity to a customer when one of the ISP's own Internet connectivity channels fail, or an important piece of equipment fails either at the ISPs own facility or the facility of a service supplier. In many situations, such a failure by the ISP to deliver a service to its customers may result in a breach of a Service Level Agreement (SLA) to its customers.

In order to provide evidence of such a breach, customers or those dependent upon the ISP may require independent analysis and reporting. Yet in many situations, only the ISP can provide the required metric data pertaining to the breach, which data may negatively impact the ISP.

Therefore, there is a need for a reporting system that can be established to record and analyze metric data from a supply network and send service advisory notifications to a list of dependents whenever a predefined threshold in the metric data has been exceeded.

Such a reporting system would provide for an independent auditor to both establish the type of metric data to be received, the source of such metric data, the channels for delivering the metric data to a processing system, and the thresholds required to ensure any SLAs are properly monitored for compliance or breach conditions. Such a needed reporting system would operate in real-time, reporting immediately to any dependents and the auditor if any of the thresholds are exceeded, and the duration thereof. The present invention accomplishes these objectives.

### SUMMARY OF THE INVENTION

The present device is a reporting system for reporting risk data from a supplier network to at least one dependent. Such a supplier network may be, for example, an

Internet-based business having a plurality of technology service providers. The dependent in such an example may be another business entity that relies on a particular level of service up-time, or an independent accounting firm having fiduciary reporting obligations to shareholders, or the like. Alternately, such a supplier network may be a network of health care providers such as doctors, hospitals, testing laboratories, and the like, and the dependents may be patients or health insurance companies who wish to ensure that confidential patient information remains protected. Alternately, such a supplier network may be a telephone services provider having a supply chain of telephone carriers, switches, voice-over-IP (VoIP) providers, or the like, the dependents of which are subscribers wanting to ensure a particular level of network uptime. Alternatively, such a supplier network may be a Cloud service provider having a dependant supply chain of Infrastructure as a Service, Platform as a Service, Software as a Service, Telecommunications as a Service, Compute as a Service, and the like, who form interdependent services who are each required to transparently ensure their own legal, contractual, service and predicate obligations regarding the data payloads, transmission services and computational results in stewardship. Many such examples of applicable supplier networks and dependents can be shown, it being understood that examples of such used herein are not intended to limit the invention in any way.

The reporting system includes a collector that is adapted to receive the metric data from the supplier network through at least one collection channel. A processing system is configured to receive and analyze the metric data collected by the collector based on at least one threshold established in a memory of the processing system, which determines based on the at least one threshold and obligatory predicates related thereto if one of the at least one dependent requires a service advisory notification due to any of the metric data exceeding at least one of the at least one threshold. The processing system is further adapted to store the metric data and results of the analysis in a forensic storage device.

A notification system is adapted to send the service advisory notice to the at least one dependent at a first dependent address stored in the memory when so directed by the processing system. Preferably the memory further includes at least two dependent addressees for each of the at least one dependent, such that the notification system may send the service advisory notification to a next dependent address upon detection that a previous notification to a previous dependent address has failed.

The memory of the processing system may further include a rule set comprising the at least one threshold and a notification list of dependents associated with each of the at least one threshold. As such, a unique list of dependents to be notified may be associated with each of the at least one threshold, with each dependent having at least one dependent address associated therewith.

The reporting system may further include an auditor that has read and write access to the at least one threshold in the memory of the processing system. The notification system further is adapted to send a notification to the auditor whenever a service advisory notice is sent to one of the at least one dependents. A heartbeat channel may further be established between the auditor and the processing system. The auditor is adapted to detect a fault condition when the heartbeat signal is not received as expected and to send a service advisory notice to the at least one dependent as a result.

In use, if any of the metric data in the supplier network exceeds one of the at least one threshold, the notification system sends the service advisory notice to the first dependent address of each dependent on the notification list associated with the threshold, and to the auditor. If any such service advisory notifications are detected as having failed to be delivered to any of the dependents, the service advisory notification is resent to the second dependent address, and so on, until the list of dependent addresses is exhausted, in which case a notification to that effect is preferably sent to the auditor.

The present invention is a reporting system that records and analyzes metric data from a supply network and sends service advisory notifications to a list of dependents whenever a predefined threshold of the metric data has been exceeded. The present system provides for an independent auditor to both establish the type of metric data to be received, the source of such metric data, the channels for delivering the metric data to a processing system, and the thresholds required to ensure any SLAs are properly monitored for compliance or breach conditions. The present invention operates in real time, reporting immediately to any dependents and the auditor if any of the thresholds are exceeded, and the duration thereof. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a diagram of the reporting system of the present invention;

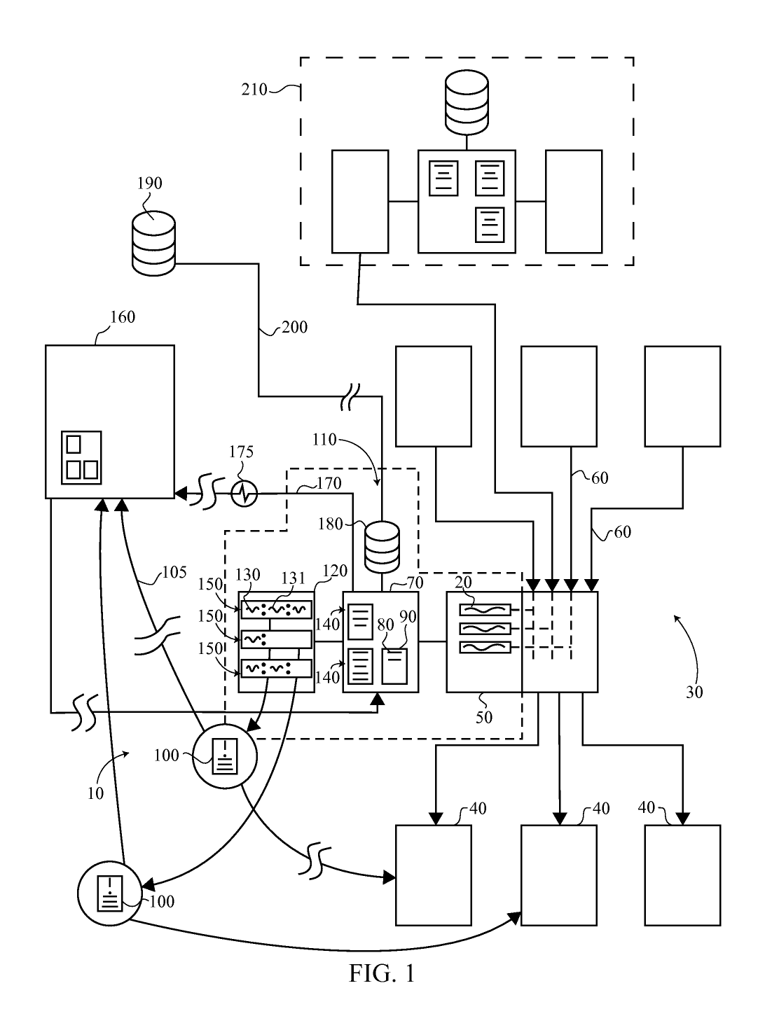

FIG. 2 is a diagram of an auditor of the present invention;

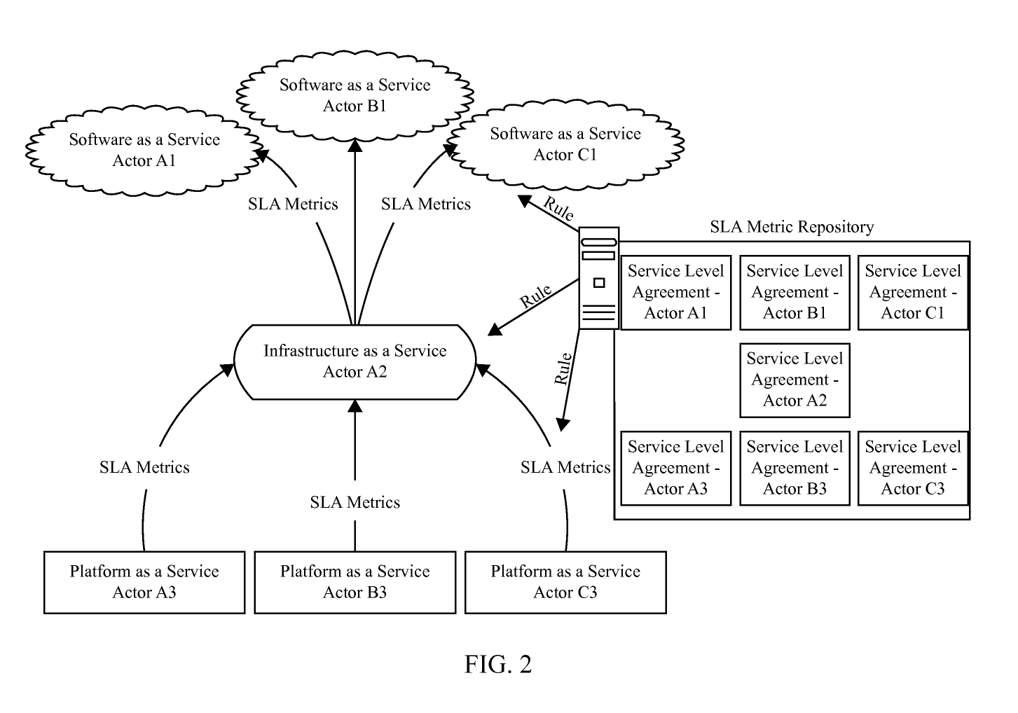

FIG. 3A is a flow diagram of a method of the present invention;

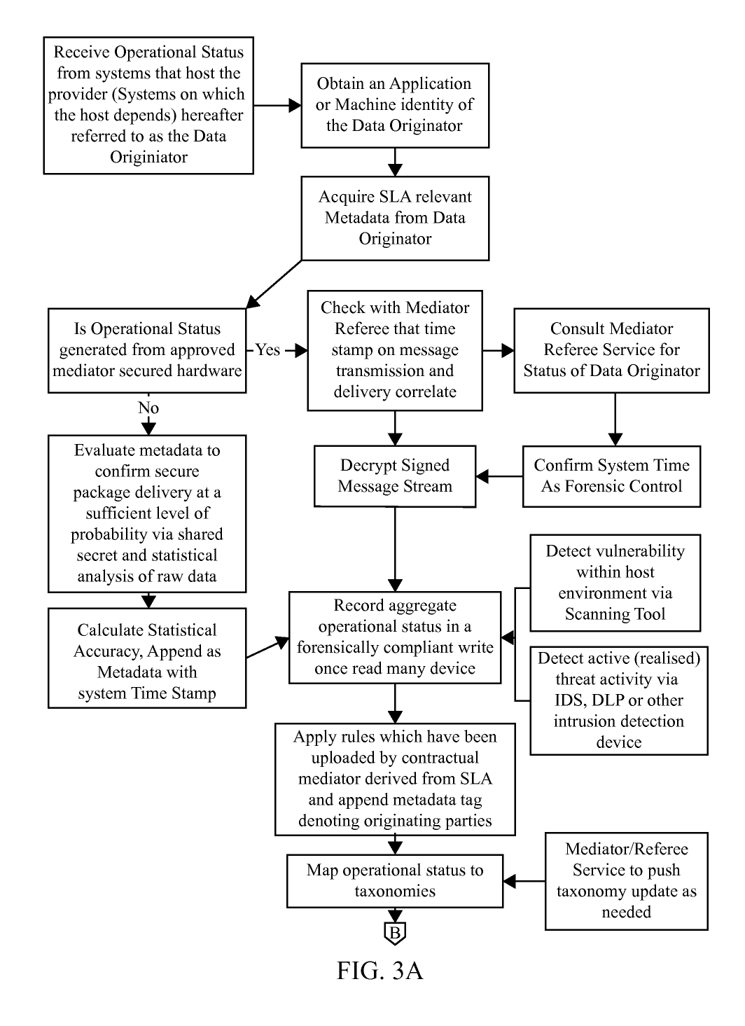

FIG. 3B is a continuation of the flow diagram in FIG. 3A;

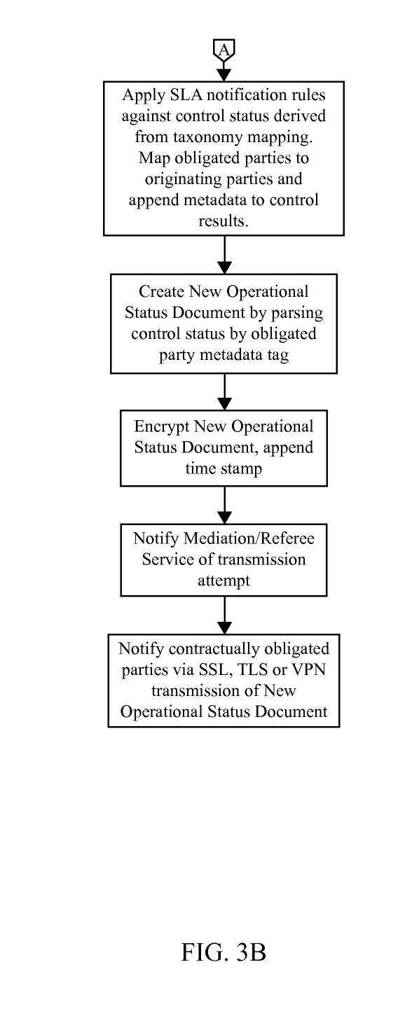

FIG. 4 is an alternate diagram of the reporting system; and

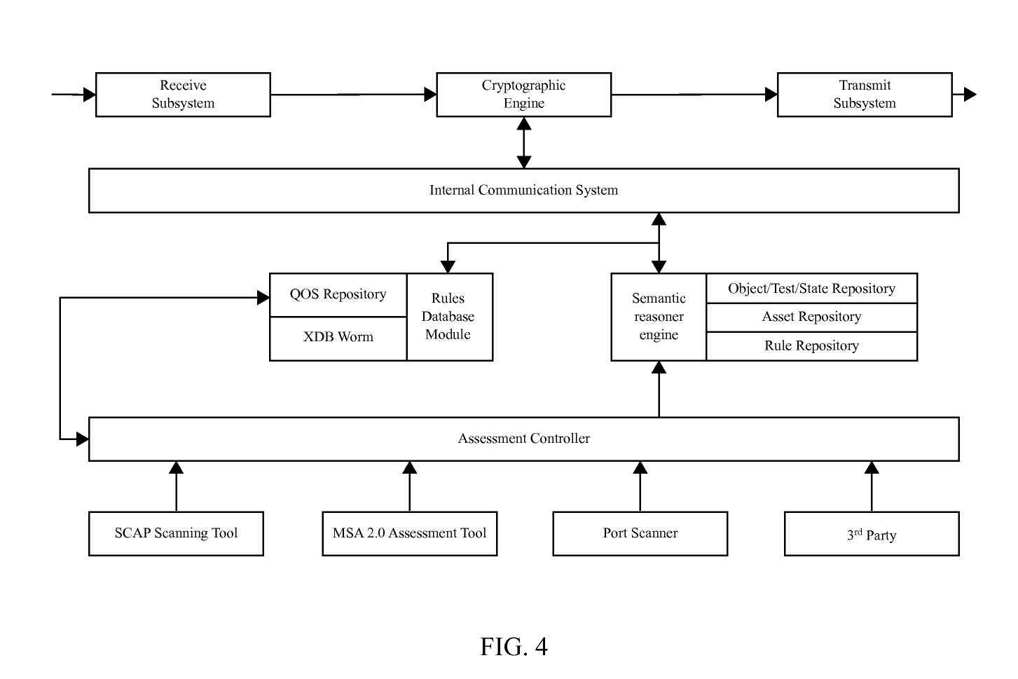

FIG. 5 is a stack diagram of the present invention.

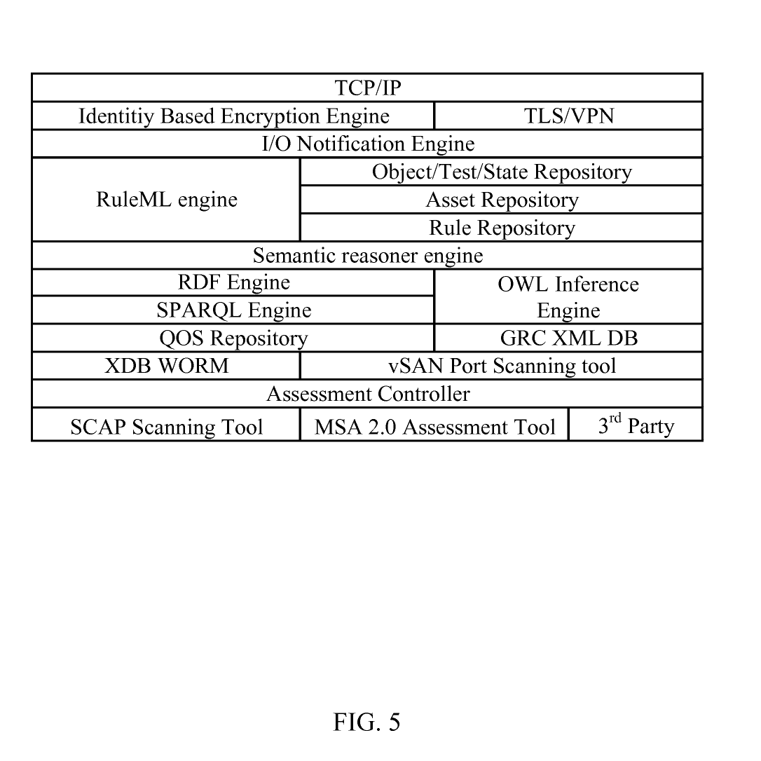

FIG. 6 is a system diagram of the present invention.

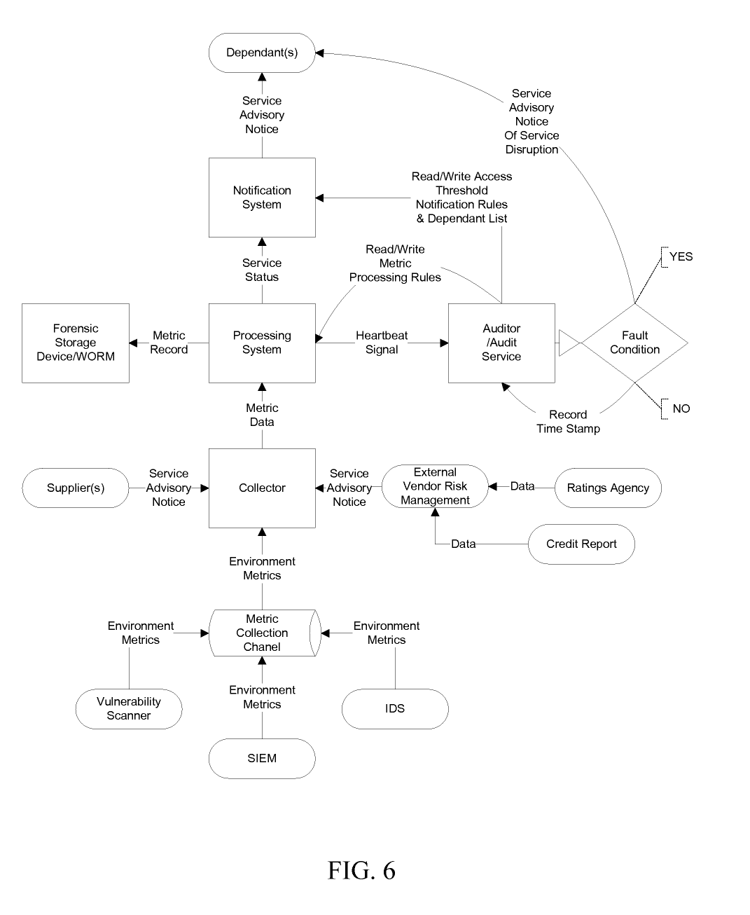

### DETAIL DESCRIPTIONS OF THE INVENTION

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The figures illustrate a reporting system 10 and method for reporting metric date 20 from a supplier network 30 to at least one dependent 40. Such a supplier network 30 may be, for example, an Internet-based business having a plurality of technology service providers. The dependent 40 in such an example may be another business entity that relies on a particular level of service up-time. Or, such a supplier network 30 may be a hard goods manufacturer having a supply chain for component parts, for example, and a dependent 40 of such a supplier network 30 may be a customer such as a chain of retail stores.

The reporting system 50 includes a collector 50 that is adapted to receive the metric data 20 from the supplier network 30 through at least one collection channel 60. A processing system 70 is configured to receive and analyze the metric data 20 collected by the collector 50 based on at least one threshold 80 established in a memory 90 of the processing system 70, which determines based on the at least one threshold 80 and obligatory predicates related thereto if one of the at least one dependent 40 requires a service advisory notification 100 due to any of the metric data 20 exceeding at least one of the at least one threshold 80.

The processing system 70 is further adapted to store the metric data 20 and results of the analysis in a forensic storage device 110, such as a local write-once read-many (WORM) drive 180 or array of such drives. A remote WORM drive 190 may be further included with a communication channel 200 established between the local 180 and remote drives 190 such that any changes to the local drive 180 are mirrored in the remote drive 190.

A notification system 120 is adapted to send the service advisory notice 100 to the at least one dependent 40 at a first dependent address 130 stored in the memory 90 when so directed by the processing system. Preferably the memory 90 further includes at least two dependent addressees 130 for each of the at least one dependent 40, such that the notification system 120 may send the service advisory notification 100 to a next dependent address 132 upon detection that a previous notification 100 to a previous dependent address (including first dependent address 130 or second dependent address 132) has failed.

In use, if any of the metric data 20 in the supplier network 30 exceeds one of the at least one threshold 80, the notification system 120 sends the service advisory notice 100 to the first dependent address 130 of the at least one dependent 40. Preferably the collector 50 is adapted to receive, as one of the collection channels 60 thereof, a service advisory notice 100 from the notification system 120 of a second reporting system 210, such that the status of one supplier network 30 may be included in the metric data of a second supplier network 30.

The memory 90 of the processing system 70 may further include a rule set 140 comprising the at least one threshold 80 and a notification list 150 of dependents 40 associated with each of the at least one threshold 80. As such, a unique list of dependents 40 to be notified may be associated with each of the at least one threshold 80, with each dependent 40 having at least one dependent address 130 associated therewith.

The reporting system 10 may further include an auditor 160 that has read and write access to the at least one threshold 80 in the memory 90 of the processing system 70. The notification system 120 further is adapted to send a notification 105 to the auditor 160 whenever a service advisory notice 100 is sent to one of the at least one dependents 40. A heartbeat channel 170 may further be established between the auditor 160 and the processing system 70, with the processing system 70 adapted to regularly send a heartbeat signal 175 through the heartbeat channel 170 to the auditor 160. The auditor 160 is adapted to detect a fault condition when the heartbeat signal 175 is not received as expected and to send a service advisory notice 100 to the at least one dependent 40.

As such, if any of the metric data 20 in the supplier network 30 exceeds one of the at least one threshold 80, the notification system 120 sends the service advisory notice 100 to the first dependent address 130 of each dependent 40 on the notification list 150 associated with the threshold 80, and to the auditor 160. If any such service advisory notifications 100 are detected as having failed to be delivered to any of the dependents 40, the service advisory notification 100 is resent to the second dependent address 132, and so on, until the list of dependent addresses (including first dependent addresses 130 and second dependent addresses 132) is exhausted, in which case a notification to that effect is preferably sent to the auditor 160.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms.

Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

Although the invention has been explained in relation to its preferred embodiment, it is to be understood that many other possible modifications and variations can be made without departing from the spirit and scope of the invention as hereinafter claimed.

What is claimed is:

1. A reporting system for reporting metric data from a supplier network to at least one dependent, comprising:
a collector adapted to receive the metric data from the supplier network through at least one collection channel;
a processing system configured to receive and analyze the metric data collected by the collector based on at least one threshold established in a memory;
the processing system determining based on the at least one threshold if a dependent requires a service advisory notification due to any of the metric data exceeding at least one of the at least one threshold;
the processing system further adapted to store the metric data and results of the analysis in a forensic storage device;
a notification system adapted to send the service advisory notice to the at least one dependent at a first dependent address stored in the memory when so directed by the processing system; and
whereby if any of the metric data in the supplier network exceeds one of the at least one thresholds, the notification system sends the service advisory notice to the first dependent address of the at least one dependent.

2. The reporting system of claim 1 wherein the memory of the processing system further includes a rule set comprising,
the at least one threshold and a notification list of dependents associated with each of the at least one threshold, whereby a unique list of dependents to be notified may be associated with each of the at least one threshold, each dependent having at least one dependent address associated therewith.

3. The reporting system of claim 1 further including,
an auditor having read and write access to the at least one threshold in the memory of the processing system, the notification system further adapted to send a notification to the auditor whenever a service advisory notice is sent to one of the at least one dependents.

4. The reporting system of claim 2 further including,
an auditor having read and write access to the rule set in the memory of the processing system, the notification system further adapted to send a notification to the auditor whenever a service advisory notice is sent to one of the at least one dependents.

5. The reporting system of claim 3 further including,
a heartbeat channel established between the auditor and the processing system, the processing system adapted to regularly send a heartbeat signal through the heartbeat channel to the auditor, the auditor adapted to detect a fault condition when the heartbeat signal is not received as expected and to send a service advisory notice to the at least one dependent.

6. The reporting system of claim 4 further including,
a heartbeat channel established between the auditor and the processing system, the processing system adapted to regularly send a heartbeat signal through the heartbeat channel to the auditor, the auditor adapted to detect a fault condition when the heartbeat signal is not received as expected and to send a service advisory notice to the at least one dependent.

7. The reporting system of claim 1 wherein the forensic storage device includes,
a local WORM drive.

8. The reporting system of claim 7 wherein the forensic storage device further includes,
a remote WORM drive having a communication channel established with the local WORM drive such that any changes to the local WORM drive are mirrored in the remote WORM drive.

9. The reporting system of claim 1 wherein the memory includes,
at least two dependent addresses for each of the at least one dependent, the notification system adapted to send the service advisory notification to a second dependent address upon detection that the first notification to the first dependent address has failed.

10. The reporting system of claim 1 wherein,
the collector is adapted to receive, as one of the collection channels thereof, a service advisory notice from the notification system of a second reporting system, whereby the status of one supplier network may be included in the metric data of a second supplier network.

11. A method of reporting metric data from a supplier network to at least one dependent, comprising the steps:
a) providing a collector adapted to receive the metric data from the supplier network through at least one collection channel; a processing system configured to receive and analyze the metric data collected by the collector based on at least one threshold established in a memory, the processing system determining based on the at least one threshold if a dependent requires a service advisory notification due to any of the metric data exceeding at least one of the at least one threshold; the processing system further adapted to store the metric data and results of the analysis in a forensic storage device; and a notification system adapted to send the service advisory notice to the at least one dependent at a first dependent address stored in the memory when so directed by the processing system;
b) the processing system analyzing the metric data from the supplier network to determine if any of the at least one threshold has been exceeded and, if so, skipping to step d);
c) repeating from step b);
d) the notification system sending the service advisory notice to the first dependent address of the at least one dependent; and
e) repeating from step b).

12. The method of claim 11 wherein step a) is:
a) providing a collector adapted to receive the metric data from the supplier network through at least one collection channel; a processing system configured to receive and analyze the metric data collected by the collector based on at least one threshold established in a memory, the processing system determining based on the at least one threshold if a dependent requires a service advisory notification due to any of the metric data exceeding at least one of the at least one threshold; the processing system further adapted to store the metric data and results of the analysis in a forensic storage device; and a notification system adapted to send the service advisory notice to the at least one dependent at a first dependent address stored in the memory when so directed by the processing system; the processing system further includes a rule set comprising the at least one threshold and a notification list of dependents associated with each of the at least one threshold;
and wherein step d) is:
d) the notification system sending the service advisory notice to each of the dependents on the notification list of dependents associated with the threshold that has been exceeded.

13. The method of claim 12 wherein step a) is:
a) providing a collector adapted to receive the metric data from the supplier network through at least one collection channel; a processing system configured to receive and analyze the metric data collected by the collector based on at least one threshold established in a memory, the processing system determining based on the at least one threshold if a dependent requires a service advisory notification due to any of the metric data exceeding at least one of the at least one threshold; the processing system further adapted to store the metric data and results of the analysis in a forensic storage device; a notification system adapted to send the service advisory notice to the at least one dependent at a first dependent address stored in the memory when so directed by the processing system; the processing system further includes a rule set comprising the at least one threshold and a notification list of dependents associated with each of the at least one threshold; and an auditor having read and write access to the rule set in the memory of the processing system, the notification system further adapted to send a notification to the auditor whenever a service advisory notice is sent to one of the at least one dependents;
and wherein step d) is:
d) the notification system sending the service advisory notice to each of the dependents on the notification list of dependents associated with the threshold that has been exceeded, and sending a notification to the auditor of each such sent service advisory notice.

14. The method of claim 13 wherein step a) is:
a) providing a collector adapted to receive the metric data from the supplier network through at least one collection channel; a processing system configured to receive and analyze the metric data collected by the collector based on at least one threshold established in a memory, the processing system determining based on the at least one threshold if a dependent requires a service advisory notification due to any of the metric data exceeding at least one of the at least one threshold; the processing system further adapted to store the metric data and results of the analysis in a forensic storage device; a notification system adapted to send the service advisory notice to the at least one dependent at a first dependent address stored in the memory when so directed by the processing system; the processing system further includes a rule set comprising the at least one threshold and a notification list of dependents associated with each of the at least one threshold; an auditor having read and write access to the rule set in the memory of the processing system, the notification system further adapted to send a notification to the auditor whenever a service advisory notice is sent to one of the at least one dependents; and a heartbeat channel established between the auditor and the processing system;
and wherein step b) is:
b) the processing system analyzing the metric data from the supplier network to determine if any of the at least one threshold has been exceeded and, if so, skipping to step d), the processing system sending a heartbeat signal through the heartbeat channel to the auditor.

15. The method of claim 11 wherein step a) is:
a) providing a collector adapted to receive the metric data from the supplier network through at least one collection channel; a processing system configured to receive and analyze the metric data collected by the collector based on at least one threshold established in a memory, the processing system determining based on the at least one threshold if a dependent requires a service advisory notification due to any of the metric data exceeding at least one of the at least one threshold; the processing system further adapted to store the metric data and results of the analysis in a forensic storage device; and a notification system adapted to send the service advisory notice to the at least one dependent at a first dependent address of at least two dependent addresses of each at least one dependent stored in the memory when so directed by the processing system; the processing system further includes a rule set comprising the at least one threshold and a notification list of dependents associated with each of the at least one threshold;
and wherein step d) is:
d) the notification system sending the service advisory notice to each of the dependents at the first dependent addresses thereof on the notification list of dependents associated with the threshold that has been exceeded;
and wherein step c) is:
c) upon detection by the notification system that the service advisory notice has failed to be delivered to a dependent address of any dependent after sending same, resending the service advisory notice to the next dependent address in the memory; and
repeating from step b).
